(19) United States
(12) Patent Application Publication
(10) Pub. No.: US 2024/0304186 A1
(43) Pub. Date: Sep. 12, 2024

(54) AUDIO SIGNAL SYNTHESIS FROM A NETWORK OF DEVICES

(71) Applicant: GOOGLE LLC, Mountain View, CA (US)

(72) Inventor: Dongeek Shin, San Jose, CA (US)

(21) Appl. No.: 18/119,137

(22) Filed: Mar. 8, 2023

(51) Int. Cl. G10L 15/20; G10L 15/16; G10L 15/30

(52) U.S. Cl. CPC G10L 15/20; G10L 15/16; G10L 15/30

(57) ABSTRACT

Merging first and second audio data to generate merged audio data, where the first audio data captures a spoken utterance of a user and is collected by a first computing device within an environment, and the second audio data captures the spoken utterance and is collected by a distinct second computing device that is within the environment. In some implementations, the merging includes merging the first audio data using a first weight value and merging the second audio data using a second weight value. The first and second weight values can be based on predicted signal-to-noise ratios (SNRs) for respective of the first audio data and the second audio data, such as a first SNR predicted by processing the first audio data using a neural network model and a second SNR predicted by processing the second audio data using the neural network model.

### BACKGROUND

Humans can engage in human-to-computer dialogs with interactive software applications referred to herein as “automated assistants” (also referred to as “chatbots,” “interactive personal assistants,” “intelligent personal assistants,” “personal voice assistants,” “conversational agents,” or simply “assistant,” etc.). For example, to provide a command or request to an automated assistant, humans (who when they interact with automated assistants may be referred to as “users”) often provide spoken natural language input (i.e., spoken utterances), in addition to or instead of textual (e.g., typed) natural language input. The automated assistant receives and processes an audio signal capturing the spoken natural language input to generate a speech recognition of the spoken natural language input. Based on the speech recognition of the spoken natural language input, the automated assistant determines user intent and/or parameters associated with the user intent, to respond to the command or request. For example, the automated assistant can respond to the command or request by providing responsive user interface output (e.g., audible and/or graphical user interface output), controlling smart device(s), and/or performing other action(s).

The accuracy of the speech recognition of the spoken natural language input degrades when the audio signal processed by the automated assistant to recognize the spoken natural language input has low signal and/or high noise. For example, the accuracy can degrade with the signal is noisy (e.g., captures loud background noise, captures reverberation, and/or has other noise). Audio denoising can improve the accuracy of the speech recognition, but at the cost of losing a non-zero amount of useful speech signal.

### SUMMARY

Implementations disclosed herein relate to generating a merged audio signal based on a plurality of audio signals respectively collected by a network of client devices (e.g., a smart watch, a smart phone, one or more earbuds, a smart speaker, and/or a laptop) in an environment surrounding a user. For instance, the plurality of audio signals can include at least: a first audio signal collected by one or more microphones of a first client device (e.g., a smart phone), and a second audio signal collected by one or more microphones of a second client device (e.g., a smart speaker) which is distinct from the first client device. The first audio signal can include: a first speech component capturing speech of the user (sometimes referred to as a “spoken utterance” or “spoken natural language input”, e.g., “Assistant, turn on the TV”) and a first background noise component capturing noise within the environment. The second audio signal can include: a second speech component capturing the speech of the user (e.g., “Assistant, turn on the TV”), and a second background noise component capturing the noises and/or alternative noise(s) within the environment.

The first and second client devices can be located at different spots with respect to the user (“source of speech”) and/or can have different orientations with respect to the user. Alternatively or additionally, the first and second client devices can be located at different spots with respect to one or more sources of noise within the environment and/or can have different orientations with respect to the one or more sources of noise. As a result, a signal-to-noise (SNR) ratio associated with the first audio signal can be different from a SNR ratio associated with the second audio signal.

In various implementations, the first audio signal can be processed to determine a first digital representation for the first audio signal, such as a spectrogram or other digital representation defining variation of a frequency of the first audio signal over time. The second audio signal can be processed to determine a second digital representation for the second audio signal, such as a spectrogram or other digital representation showing/defining variation of a frequency of the second audio signal over time. The first spectrogram can be processed using a trained neural network model as input, to generate a first output that indicates/reflects a predicted SNR for the first audio signal (may be referred to as “first SNR”). The predicted SNR for the first audio signal (“first SNR”) can be a ratio or numeric value predicting a strength of the first speech component relative to a strength of the first background noise component. Optionally, the first SNR can be determined based on the first output.

Similarly, the second spectrogram can be processed using the trained neural network model as input, to generate a second output that indicates/reflects a predicted SNR for the second audio signal (may be referred to as “second SNR”). The predicted SNR for the second audio signal (“second SNR”) can be a ratio or numeric value predicting a strength of the second speech component relative to a strength of the second background noise component, and/or can be determined based on the second output. In some implementations, the first output of the trained neural network in processing the first audio signal and the second output of the trained neural network in processing the second audio signal can be within a range from 0 to 1. As a non-limiting example, if the first output is approximately “0”, the first output of being approximately “0” can indicate extremely low SNR (e.g. no/low signal and/or high noise). If the first output is approximately “1”, the first output of being approximately “1” can indicate extremely high SNR (e.g., high signal and/or low/no noise). Likewise, if the output is “0.8” it can indicate more favorable SNR that an output of “0.5”, and an output of “0.5” can indicate more favorable SNR than an output of “0.25”.

Based on the first output and the second output (alternatively, based on the first and second SNRs), a first weight value and a second weight value can be determined. In some implementations, the first weight value can be determined as a first percentage calculated by dividing the first output by a sum of the first and second outputs, and the second weight value can be determined as a second percentage calculated by dividing the second output by a sum of the first and second outputs, where a sum of the first and second weight values equals approximately 1. In some implementations, the first weight value can be determined as a first percentage calculated by dividing the first SNR by a sum of the first and second SNRs, and the second weight value can be determined as a second percentage calculated by dividing the second SNR by a sum of the first and second SNRs, where a sum of the first and second weight values equals approximately 1. For example, if the first SNR is 0.8 and the second SNR is 0.5, the first weight value can be 0.615 (0.8/1.3) and the second weight value can be 0.385 (0.5/1.3).

Based on the first and second weight values and using the first and second audio signals, a merged audio signal can be determined. For instance, the merged audio signal can be generated by combining/merging the first audio signal multiplied by the first weight value and the second audio signal multiplied by the second weight value. In the merging, for example, audio frames from the first audio signal can be first weighted with the first weight value and then combined with corresponding audio frames, from the second audio signal, that are weighted with the second weight value. The merged audio signal can then be provided for further processing. For instance, the merged audio signal can be processed, e.g., using an automatic speech recognition (“ASR”) engine, to recognize the speech (e.g., “Assistant, turn on the TV”) of the user. By processing the merged audio signal instead of processing the first audio signal or the second audio signal to recognize the speech, the chances of recognizing the speech based on a noisy audio signal (e.g., an audio signal that has a relatively low SNR) can be reduced, so that the accuracy in recognizing the speech can be improved. Moreover, by processing the merged audio signal instead of denoising the first (or second) audio signal, useful information contained in the first (or second) speech component will not be removed or be sacrificed when the first (or second) audio signal is denoised to remove or suppress the first (or second) background noise component.

In some implementations, the first audio signal (and/or the second audio signal) can be transmitted from the first client device (or the second client device if the second audio signal is to be transmitted) to a server (local or remote) for processing to acquire the first spectrogram (and/or the second spectrogram). In various implementations, the server can include or otherwise access the trained neural network to process the first spectrogram and to process the second spectrogram, thereby generating the first output indicating the first SNR and the second output indicating the second SNR. In various implementations, the trained neural network can be a convolutional neural network (CNN) trained to process a spectrogram to generate an output that indicates a SNR for an audio signal represented by the spectrogram.

In some implementations, the first client device (or another local device, which can be the second client device or a device different from the first and second client device) can process the first audio signal to acquire the first spectrogram, and/or can include the trained neural network for processing the first spectrogram. For instance, the first client device can locally store the trained neural network, and process the first spectrogram using the trained neural network as input, to generate the first output. In these implementations, the second audio signal can be transmitted from the second client device to the first client device, for processing to generate the second spectrogram, where the second spectrogram can be further processed using the trained neural network to generate the second output.

Alternatively, in some implementations, the second client device can process the second audio signal to generate the second spectrogram, where the second spectrogram (and/or the second audio signal) can be transmitted to the first client device to be processed, using the trained neural network, to generate the second spectrogram. In these implementations, the first client device can perform further processing (e.g., first and second weight value determination, speech recognition, etc.) using the first and second output. Alternatively, in some implementations, the second client device can also locally store the trained neural network, and can process the second spectrogram, using the trained neural network (locally stored at the second client device) as input, to generate the second output. In these implementations, the first output determined by the first client device can be shared with the second client device, for the second client device to determine the first and second weight values. Or, the second output determined by the second client device can be shared with the first client device, for the first client device to determine the first and second weight values. The device(s) to process the audio signals and/or generate spectrograms, weight values, or merged audio signal are not limited to descriptions provided herein, and can be any applicable devices or any applicable combination thereof.

In some implementations, the first weight value (and/or the first SNR) can be stored locally in association with the first client device, and the second weight value (and/or the second SNR) can be stored locally in association with the second client device. As a non-limiting example, the first client device can be a smart TV that is fixed to a wall of a living room, the second client device can be a smart speaker placed on a side table next to a chair of the living room, and the user can sit on the chair to read newspapers or watch TV in the living room. In this example, because the relative position between the user and the smart speaker and the relative position between the user and the smart TV can remain substantially the same, the first SNR and the second SNR may not need to be re-computed frequently, and the first weight value and the second weight value can be stored for use in combining/merging subsequent audio signals correspondingly collected by the smart TV and the smart speaker.

For instance, one or more microphones of the first client device can capture/collect an additional first audio signal for an additional speech (e.g., “Assistant, raise the voice of the TV”) of the user, and one or more microphones of the second client device can capture/collect an additional second audio signal for the additional speech (e.g., “Assistant, raise the voice of the TV”). In this instance, the additional first audio signal multiplied by the first weight value can be combined with the additional second audio signal multiplied by the second weight value to generate an additional combined audio signal. The additional combined audio signal, instead of the additional first audio signal or the additional second audio signal, can be processed to recognize the additional speech (e.g., “Assistant, raise the voice of the TV”).

In some implementations, the first SNR and/or the second SNR stored locally can be updated at regular or irregular intervals (e.g., every 500 milliseconds) during (or subsequent to) detection of a spoken utterance, or can be updated in response to detecting a triggering event that triggers SNR re-computation. The triggering event can be, for instance, a detection of movement of the first (or second) client device and/or movement of the user relative to the first (or second) client device. For instance, the first client device can include a first motion sensor detecting movement within a first surround region of the first client device, and the second client device can include a second motion sensor detecting movement within a second surrounding region of the second client device. The first (or second) motion sensor can be, for instance, an accelerometer, a gyroscope, and/or other types of motion sensors (or any combination thereof) embedded in the first (or second) client device, that determines whether the first (or second) client device moves in respect to location and/or orientation. The triggering event can be the first motion sensor detecting a movement of the first client device (or the user), or can be the second motion sensor detecting a movement of the second client device (or the user).

As a non-limiting example, the triggering event can be the first motion sensor detecting the movement of the first client device with respect to the user, while the second motion sensor detects no movement of the second client device with respect to the user. In this example, the first SNR can be re-computed or updated using the trained neural network. The re-computed first SNR can be applied, along with the second SNR, to determine an update to the first weight value (may also be referred to as “updated first weight value”) and an update to the second weight value (may also be referred to as “updated second weight value”). For instance, the updated first weight value can be determined by dividing the re-computed first SNR by a sum of the re-computed first SNR and the second SNR which is locally stored (without being re-computed or updated). The updated second weight value can be determined by dividing the second SNR by the sum of the re-computed first SNR and the second SNR locally stored.

As another non-limiting example, the triggering event can be the first motion sensor detecting the movement of the first client device with respect to the user, while the second motion sensor detects a movement of the second client device with respect to the user. In this example, both the first SNR and the second SNR can be re-computed using the trained neural network. The re-computed first SNR and the re-computed second SNR can be applied to determine an update to the first weight value (may also be referred to as “updated first weight value”) and an update to the second weight value (may also be referred to as “updated second weight value”). For instance, the updated first weight value can be determined by dividing the re-computed first SNR by a sum of the re-computed first SNR and the re-computed second SNR. The updated second weight value can be determined by dividing the re-computed second SNR by the sum of the re-computed first SNR and the re-computed second SNR.

In some implementations, the triggering event can be, for instance, a detection of noise (or variation thereof) within the environment of the user. In response to detection of the triggering event (i.e., here, “noise” or a variation in the noise), both the first and second weight values can be re-computed for utilization in merging of a subsequent audio signal collected by the first client device and a corresponding subsequent audio signal collected by the second client device.

In some implementations, the aforementioned first audio signal can be divided into a plurality of portions, such as a plurality of audio frames (e.g., a total number of M audio frames), and the second audio signal can be divided into a plurality of audio frames (e.g., a total number of M audio frames). As a non-limiting example, the first audio signal can include, or be divided into, three audio frames F11, F12, and F13. The second audio signal can include, or be divided into, three audio frames F21, F22, and F23, where audio frame F21 of the second audio signal corresponds to audio frame F11 of the first audio signal, audio frame F22 of the second audio signal corresponds to audio frame F12 of the first audio signal, and audio frame F23 of the second audio signal corresponds to audio frame F13 of the first audio signal.

Continuing with the non-limiting example above, the audio frame F11 of the first audio signal can be processed to acquire a spectrogram of the audio frame F11, and the spectrogram of the audio frame F11 can be processed using the trained neural network to generate an output indicating a signal-to-noise ratio “SNR_11” for the audio frame F11. The audio frame F21 of the second audio signal can be processed to acquire a spectrogram of the audio frame F21, and the spectrogram of the audio frame F21 can be processed using the trained neural network to generate an output indicating a signal-to-noise ratio “SNR_21” for the audio frame F21. Based on the SNR_11 for the audio frame F11 and SNR_21 for the audio frame F21, a first weight value w11 for the audio frame F11 and a second weight value w21 for the audio frame F21 can be determined. The audio frame F11 multiplied by the first weight value w11 and the audio frame F21 multiplied by the second weight value w21 can be combined/merged to generate a combined/merged audio frame F1, where speech recognition can be performed on the combined/merged audio frame F1 (instead of or in addition to performing speech recognition on the audio frame F21 or the audio frame F11).

Similarly, the audio frame F12 of the first audio signal can be processed to acquire a spectrogram of the audio frame F12, and the spectrogram of the audio frame F12 can be processed using the trained neural network to generate an output indicating a signal-to-noise ratio “SNR_12” for the audio frame F12. The audio frame F22 of the second audio signal can be processed to acquire a spectrogram of the audio frame F22, and the spectrogram of the audio frame F22 can be processed using the trained neural network to generate an output indicating a signal-to-noise ratio “SNR_22” for the audio frame F21. Based on the SNR_12 for the audio frame F12 and SNR_22 for the audio frame F22, a first weight value w12 for the audio frame F12 and a second weight value w22 for the audio frame F22 can be determined. The audio frame F12 multiplied by the first weight value w12 and the audio frame F22 multiplied by the second weight value w22 can be combined to generate a combined audio frame F2, where speech recognition can be performed on the combined audio frame F2 (instead of or in addition to performing speech recognition on the audio frame F12 or the audio frame F22).

Similarly, the audio frame F13 of the first audio signal can be processed to acquire a spectrogram of the audio frame F13, and the spectrogram of the audio frame F13 can be processed using the trained neural network to generate an output indicating a signal-to-noise ratio “SNR_13” for the audio frame F13. The audio frame F23 of the second audio signal can be processed to acquire a spectrogram of the audio frame F23, and the spectrogram of the audio frame F23 can be processed using the trained neural network to generate an output indicating a signal-to-noise ratio “SNR_23” for the audio frame F23. Based on the SNR_13 for the audio frame F13 and SNR_23 for the audio frame F23, a first weight value w13 for the audio frame F13 and a second weight value w23 for the audio frame F23 can be determined. The audio frame F13 multiplied by the first weight value w13 and the audio frame F23 multiplied by the second weight value w23 can be combined to generate a combined audio frame F3, where speech recognition can be performed on the combined audio frame F3 (instead of or in addition to performing speech recognition on the audio frame F13 or the audio frame F23).

It is noted that the network of client devices are not limited to including only the first client device and the second client device. For instance, the network of client devices can include a first client device, a second client device, . . . , and an Nth client device. In this instance, given the user providing the speech (e.g., “Assistant, turn on the TV”), the first client device can capture a first audio signal having a first speech component that corresponds to the speech (“Assistant, turn on the TV”), the second client device can capture a second audio signal having a second speech component that corresponds to the speech (“Assistant, turn on the TV”), . . . , and the Nth client device can capture an Nth audio signal having an Nth speech component that corresponds to the speech (“Assistant, turn on the TV”). The first, second, . . . , and Nth audio signal can be processed to respectively generate a first spectrogram for the first audio signal, a second spectrogram for the second audio signal, . . . , and an Nth spectrogram for the Nth audio signal.

The first, second, . . . , and Nth spectrograms can each be processed using the aforementioned trained neural network, to generate a first output indicating a first SNR for the first audio signal, a second output indicating a second SNR for the second audio signal, . . . , and an Nth output indicating an Nth SNR for the Nth audio signal. In this case, a first weight value can be determined by dividing the first output (or the first SNR) by a sum of the first, second, . . . , and Nth outputs (or SNRs). A second weight value can be determined by dividing the second output (or the second SNR) by the sum of the first, second, . . . , and Nth outputs (SNRs), . . . , and an Nth weight value can be determined by dividing the Nth output (or the Nth SNR) by the sum of the first, second, . . . , and Nth outputs (or SNRs). The first audio signal multiplied by the first weight value, the second audio signal multiplied by the second weight value, . . . , and the Nth audio signal multiplied by the Nth weight value can be combined/merged to generate a merged audio signal, for further processing (e.g., speech recognition).

The above is provided merely as an overview of some implementations. Those and/or other implementations are disclosed in more detail herein.

Various implementations can include a non-transitory computer readable storage medium storing instructions executable by a processor to perform a method such as one or more of the methods described herein. Yet other various implementations can include a system including memory and one or more hardware processors operable to execute instructions, stored in the memory, to perform a method such as one or more of the methods described herein.

### BRIEF DESCRIPTION OF THE DRAWINGS

The above and other aspects, features, and advantages of certain implementations of the present disclosure will be more apparent from the following description taken in conjunction with the accompanying drawings. In the drawings:

FIG. 1A depicts a block diagram of an example environment that demonstrates various aspects of the present disclosure, and in which implementations disclosed herein can be implemented.

FIG. 1B is a flow diagram showing the processing and combining of a plurality of audio signals, in accordance with various implementations.

FIG. 2A, FIG. 2B, and FIG. 2C together provide a flow diagram showing the processing of a plurality of audio signals, in accordance with various implementations.

FIG. 3 illustrates an example method for generating a merged audio signal, in accordance with various implementations.

FIG. 4 illustrates an example method for updating one or more weight values for generation of a merged audio signal, in accordance with various implementations.

FIG. 5 illustrates an example method for dynamically updating one or more weight values, in accordance with various implementations.

FIG. 6 illustrates an example architecture of a computing device, in accordance with various implementations.

### DETAILED DESCRIPTION

The following description with reference to the accompanying drawings is provided for understanding of various implementations of the present disclosure. It's appreciated that different features from different implementations may be combined with and/or exchanged for one another. In addition, those of ordinary skill in the art will recognize that various changes and modifications of the various implementations described herein can be made without departing from the scope and spirit of the present disclosure. Descriptions of well-known or repeated functions and constructions may be omitted for clarity and conciseness.

The terms and words used in the following description and claims are not limited to the bibliographical meanings, and are merely used to enable a clear and consistent understanding of the present disclosure. Accordingly, it should be apparent to those skilled in the art that the following description of various implementations of the present disclosure is provided for the purpose of illustration only and not for the purpose of limiting the present disclosure as defined by the appended claims and their equivalents.

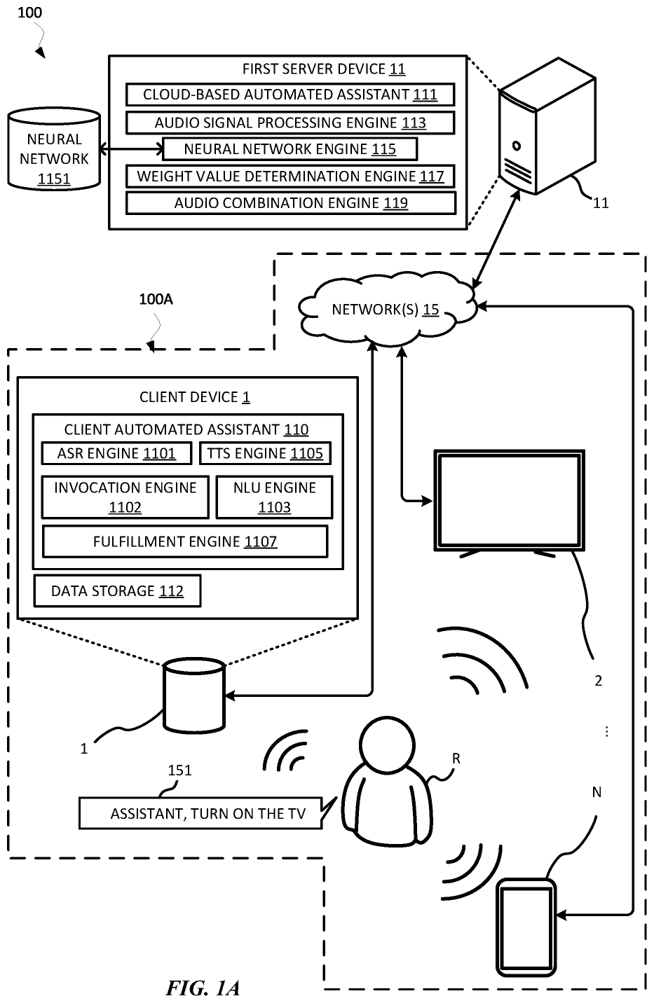

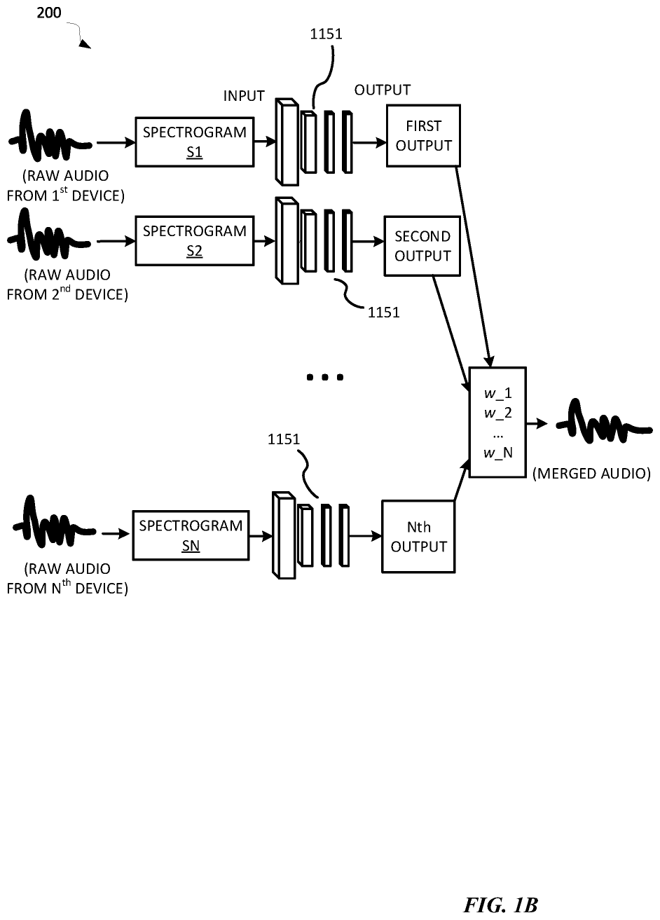

FIG. 1A depicts a block diagram of an example environment 100 that demonstrates various aspects of the present disclosure, and in which implementations disclosed herein can be implemented. FIG. 1B is a flow diagram showing the processing and combining/merging of a plurality of audio signals, in accordance with various implementations. As shown in FIG. 1A, the environment 100 can include a local environment 100A surrounding a user R, where the local environment 100A can include a plurality of client devices (e.g., a first client device 1, a second client device 2, . . . , and an Nth client device N, where N is a positive integer greater than or equal to 1). One or more of the first, second, . . . , and Nth client devices can include a client automated assistant. As a non-limiting example, referring to FIG. 1A, the first client device can include a client automated assistant 110, and/or a data storage 112. Alternatively, in some implementations, the first client device 1, the second client device 2, . . . , and the Nth client device N can each include a client automated assistant (that is the same as or similar to the client automated client 110), and one or more other applications (not shown, which can include a messaging application, a browser application, etc.). However, not all of the first, second, . . . , and Nth client devices need to include a client automated assistant (that is the same as or similar to the client automated client 110).

The plurality of client devices can include, for example, a cell phone, a stand-alone interactive speaker, a computer (e.g., laptop, desktop, notebook), a tablet, a robot, a smart appliance (e.g., smart TV), a messaging device, an in-vehicle device (e.g., in-vehicle navigation system or in-vehicle entertainment system), a wearable device (e.g., watch or glasses), a virtual reality (VR) device, an augmented reality (AV) device, or a personal digital assistant (PDA), and the present disclosure is not limited thereto.

In some implementations, optionally, the environment 100 can further include one or more server devices (e.g., a first server device 11). The first server device 11 can include a cloud-based automated assistant 13. The first server device 11 can communicate with the first client device 1, the second client device 2, . . . , and the Nth client device N via one or more networks 15. The one or more networks 15 can be, or can include, for example, a local area network (LAN), a wide area network (WAN) such as the Internet, and/or any other appropriate network.

The client automated assistant 110 can have a plurality of local components including, for example, an automatic speech recognition (ASR) engine 1101, a natural language understanding (NLU) engine 1103, a text-to-speech (TTS) engine 1105, and/or a fulfillment engine 1107. The plurality of local components of the client automated assistant 110 can optionally further include an invocation engine 1102. The cloud-based automated assistant 13 can have components the same as or similar to the client automated assistant 110 while the components of the cloud-based automated assistant can possess stronger processing capabilities than their counterparts of the client automated assistant 110. Repeated descriptions of the components of the cloud-based automated assistant 13 is omitted herein. It's noted that when combined, the client automated assistant 110 and the cloud-based automated assistant 111 can be referred to as “automated assistant”.

When the first client device 1 is powered on, the client automated assistant 110 is often configured in a hotword restricted listening state in which the invocation engine 1102 is activated to process audio data received via the first client device 1. The invocation engine 1102, for instance, accesses a hotword detection model to process audio data that captures a spoken utterance 101 as input, to generate an output indicating whether the spoken utterance 101 includes a hotword (e.g., “Assistant”). The hotword detection model can be, for instance, a machine learning model that is trained to detect presence of a particular hotword (e.g., the aforementioned hotword “Assistant”) in a given instance of audio data. The particular hotword can be customized and pre-configured based on a type or function of the automated assistant. In other words, different automated assistants developed by different developers/parties can have different hotwords pre-configured.

By requiring a user to explicitly invoke the client automated assistant 110 using the hotword before the automated assistant can fully process the spoken utterance 101, user privacy can be preserved and resources (computational, battery, etc.) can be conserved. It's noted that, in some cases, the client automated assistant 110 may also be invoked without utilization of the hotword. For instance, the client automated assistant 110 can be invoked in response to a touch gesture, a touch-free gesture, presence detection, and/or a gaze of the user.

In various implementations, the client automated assistant 110 and/or the cloud-based automated assistant 111 can receive and process the audio data that captures the spoken utterance 101 using an ASR model in response to invocation of the client automated assistant 1110. For instance, the ASR engine 1101 of the client automated assistant 110 can process, using the ASR model (not illustrated), the audio data that captures the spoken utterance 101, to generate a speech recognition (may also be referred to as “transcription”) of the spoken utterance 101. As a non-limiting example, the speech recognition of the spoken utterance 101 can be determined as being “Assistant, turn on the TV”.

The NLU engine 1103 can determine semantic meaning(s) of audio (e.g., the aforementioned audio data capturing the spoken utterance 101) and/or a text (e.g., the aforementioned speech recognition that is converted by the ASR engine 1101 from the audio data), and decompose the determined semantic meaning(s) to determine intent(s) and/or parameter(s) for an assistant action (e.g., generating/displaying responsive content, controlling a third-party device to perform a third-party action). For instance, the NLU engine 1103 can process the speech recognition (e.g., “Assistant, turn on the TV”) of the spoken utterance 101, to determine an intent (e.g., turn on a device) of the user and one or more parameters (the device being “TV”) for the assistant action of “turn on TV”.

In some implementations, the NLU engine 1103 can process, using a NLU machine learning model, the aforementioned speech recognition (e.g., “Assistant, turn on the TV”) as input. In processing the aforementioned speech recognition, the NLU machine learning model can generate an output that indicates the aforementioned intent and/or the one or more parameters. Such output of the NLU machine learning model can further indicate or include a NLU score indicating whether the intent (e.g., turn on <device>) and/or the one or more parameters (e.g., device name for the device: “TV”) are feasible.

In some implementations, when the NLU score is below a predetermined NLU score threshold, the NLU engine 1103 can determine that the intent (e.g., turn on <device>) and/or the one or more parameters (e.g., device name for the device: “TV”) indicated by the output of the NLU machine learning model, are unresolved for the spoken utterance 101. When the user intent and/or the associated parameter(s) are determined as being unresolved, a default message can be rendered to the user. The default message, e.g., “sorry, I don't understand, please try again”, can be rendered audibly and/or visually.

In various implementations, the first client device 1, the second client device 2, . . . , and the Nth client device N within the local environment 100A of user R can each include one or more microphones. User R can provide one or more spoken utterances (“one or more speeches”), where the one or more spoken utterances can be captured/collected by the one or more microphones of each of the first, second, . . . , and Nth client devices. For example, user R can provide a speech 151 (sometimes referred to as “a spoken utterance”) such as “Assistant, turn on the TV”. In this example, the first client device 1 can, via one or more microphones (e.g., embedded), capture a first audio signal (may also be referred to as “first audio data”, or “raw audio from 1^{st} device” as seen in FIG. 1B) that includes: (1) a first speech component corresponding to the speech 151 detected by the one or more microphones of the first client device 1, and (2) a first background noise component corresponding to background noise detected by the one or more microphones of the first client device 1.

Continuing with the above example, the second client device 2 can, via one or more microphones (e.g., embedded), capture a second audio signal (may also be referred to as “second audio data”, or “raw audio from 2^{nd} device” as seen in FIG. 1B) that includes: (1) a second speech component corresponding to the speech 151 detected by the one or more microphones of the second client device 2, and (2) a second background noise component corresponding to background noise detected by the one or more microphones of the second client device 2. The Nth client device N can, via one or more microphones (e.g., embedded), capture an Nth audio signal (may also be referred to as “Nth audio data”, or “raw audio from Nth device” as seen in FIG. 1B) that includes: (1) an Nth speech component corresponding to the speech 151 detected by the one or more microphones of the Nth client device N, and (2) an Nth background noise component corresponding to background noise detected by the one or more microphones of the Nth client device N.

The first, second, . . . , and Nth audio signals can be transmitted, for example, to the first server device 11 to be processed. For instance, in addition to the aforementioned cloud-based automated assistant 111, the first server device 11 can include an audio signal processing engine 113. The audio signal processing engine 113 can process/convert the first audio signal to a first spectrogram (“S1” in FIG. 1B) for the first audio signal, convert the second audio signal to a second spectrogram (“S2” in FIG. 1B) for the second audio signal, . . . , and convert the Nth audio signal to an Nth spectrogram (“SN” in FIG. 1B) for the Nth audio signal. In various implementations, the first server device 11 can further include a neural network engine 115 that processes the first spectrogram for the first audio signal as input, using a trained neural network 1151, to generate a first output (which can be, for instance, a single numeric value within the range from 0 to 1, e.g., 0.7) indicating a first SNR for the first audio signal. Similarly, the neural network engine 115 processes the second spectrogram for the second audio signal as input, using the trained neural network 1151, to generate a second output (e.g., 0.6) indicating a second SNR for the second audio signal, . . . , and processes the Nth spectrogram for the Nth audio signal as input, using the trained neural network 1151, to generate the Nth output (e.g., 0.3) indicating an Nth SNR for the Nth audio signal.

In various implementations, the first server device 11 can further include a weight value determination engine 117 to determine a first weight value w_1 for the first audio signal, a second weight value w_2 for the second audio signal, . . . , and an Nth weight value w_N for the Nth audio signal, based on the aforementioned first, second, . . . , and Nth output. For instance, the weight value determination engine 117 can determine the first weight value by dividing the first output (e.g., 0.7) by a sum (e.g., 0.7+0.6+ . . . +0.3) of the first, second, . . . , and Nth output. The weight value determination engine 117 can determine the second weight value by dividing the second output (e.g., 0.6) by the sum (e.g., 0.7+0.6+ . . . +0.3) of the first, second, . . . , and Nth output. The weight value determination engine 117 can determine the Nth weight value by dividing the Nth output (e.g., 0.3) by the sum (e.g., 0.7+0.6+ . . . +0.3) of the first, second, . . . , and Nth output.

In various implementations, the first server device 11 can further include an audio combination engine 119 to combine the first, second, . . . , and Nth audio signals in a weighted manner (e.g., based on the first weight value, the second weight value, . . . , the Nth weight value), to generate a merged audio signal (sometimes referred to as “combined audio signal”, “merged audio stream”, or “merged audio data”). For instance, the audio combination engine 119 can combine the first audio signal multiplied by the first weight value, the second audio signal multiplied by the second weight value, . . . , and the Nth audio signal multiplied by the Nth weight value, to generate the merged audio signal. An equation for the above combination is shown as below:

Merged audio signal=first audio signal×first weight value+second audio signal×second weight value+ . . . ,+Nth audio signal×Nth weight value.

In various implementations, the first server device 11 can transmit the weighted audio signal (“merged audio signal”) to the ASR engine 1101 of the client automated assistant 110 (or an ASR engine of the cloud-based automated assistant 111) to generate a speech recognition of the speech 151, where the speech recognition of the speech 151 can be processed by the NLU engine 1103 (or its cloud-based counterpart) to determine a responsive assistant action or a response (audible and/or graphical) in natural language. In various implementations, the merged audio signal can be transmitted to the invocation engine 1102 to determine (e.g., using the aforementioned hotword detection model) whether the speech 151 includes a hotword (e.g., “Assistant”) that invokes the automated assistant. The merged audio signal can be further processed by any other applicable components within or out of the environment 100, and the further processing of the merged audio signal is not limited to descriptions provided herein.

In some implementations, instead of being transmitted to the first server device 11 for processing, the first, second, . . . , and Nth audio signals can be processed by one or more local devices, without utilizing any remote device(s). For example, instead of or in addition to being included in the first server device 11, the audio signal processing engine 113 (or a similar engine), the neural network engine 115 (or a similar engine), the weight value determination engine 117 (or a similar engine), the audio combination engine 119 (or a similar engine), and/or the trained neural network 1151 (or a similar neural network) can be stored/included in the first client device 1 (or be included in additional local devices such as the second client device 2, etc.). In some cases, the similar engines of the audio signal processing engine 113, the neural network engine 115, the weight value determination engine 117, and/or the audio combination engine 119, when being included in the first client device (or additional local devices), can possess fewer computing capabilities (compared to that in the first server device 11) while providing the same or similar functions, to reduce consumption of computational resources. The trained neural network 1151, when included in the first server device 11 (or additional local devices), can be trained less extensively (compared to the one stored or accessible by the first server device 11).

In the implementations above, as a non-limiting example, the first client device 1 can receive the second, third, . . . , and Nth audio signals respectively from the second client device 2, . . . , and the Nth client device N. In these implementations, the first, second, . . . , and the Nth audio signals can be respectively processed by the first client device 1 to generate the first spectrogram S1, the second spectrogram S2, . . . , and the Nth spectrogram SN. The first client device 1 can further process the first spectrogram S1, the second spectrogram S2, . . . , and the Nth spectrogram SN, respectively, using a trained neural network the same as or similar to the trained neural network 1151, to generate the first, second, . . . , and Nth outputs, respectively. The first client device 1 can then determine the first, second, . . . , and Nth weight values based on the first, second, and Nth outputs, and merge the first, second, . . . , and Nth audio signals using the determined first, second, . . . , and Nth weight values.

Alternatively, in some implementations, the first client device 1 can determine the first spectrogram S1, the second client device 2 can determine the second spectrogram S2, . . . , and the Nth client device N can determine the Nth spectrogram SN. In these implementations, the first client device 1 can receive, from the second client device 2, the second spectrogram S2 determined by the second client device, along with the second audio signal, . . . , and receive, from the Nth client device N, the Nth spectrogram SN along with the Nth audio signal, for processing to generate the first, second, . . . , and Nth output. The first client device 1 can then determine the first, second, . . . , and Nth weight values based on the first, second, and Nth outputs, and merge the first, second, . . . , and Nth audio signals using the determined first, second, . . . , and Nth weight values.

Alternatively, in some implementations, the first client device 1 can determine the first spectrogram S1, the second client device 2 can determine the second spectrogram S2, . . . , and the Nth client device N can determine the Nth spectrogram SN. The first client device 1 can process the first spectrogram S1 to determine the first SNR (or generate the first output), the second client device 2 can process the second spectrogram S2 to determine the second SNR (or generate the second output), . . . , and the Nth client device N can process the Nth spectrogram to determine the Nth SNR (or generate the Nth output). In these implementations, the first client device 1 can receive the second SNR (or the second SNR) from the second client device 2, . . . , and receive the Nth SNR (or the Nth SNR) from the Nth client device N. The first client device 1 can then determine the first, second, . . . , and Nth weight values based on the first, second, and Nth SNRs (or outputs), and merge the first, second, . . . , and Nth audio signals using the determined first, second, . . . , and Nth weight values.

In some implementations, while the first, second, . . . , and Nth client device can respectively collect the first, second, . . . , and the Nth audio signals, not all of the first, second, . . . , and Nth audio signals need to be processed (e.g., to determine corresponding spectrograms/SNRs/weight values, etc.). Given the speech 151 of “Assistant, turn on the TV” as a non-limiting example, a client device F (out of the network of client devices that include the first, second, . . . , and Nth client devices) can collect an F^{th} audio signal corresponding to the speech 151 but is not responsive to the speech 151. As a non-limiting example, the client device F may be a device invokable by a hotword/hot phrase (e.g., “Hey, friend”, which is different from “Assistant”), but not invokable by the hotword “Assistant”. In this case, the F^{th} audio signal collected by the client device F can be discarded and not used (or transmitted) for feature extraction to generate a corresponding spectrogram and any subsequent processing (e.g., generating a corresponding output or SNR, or for weight value determination and audio signal merging, etc.).

In some implementations, the first weight value (or first output, or first SNR) can be stored in the data storage 112 (or other data storage, local or remote) in association with the first client device 1, the second weight value (or second output, or second SNR) can be stored in a data storage (local or remote) in association with the second client device 2, . . . , and the Nth weight value (or Nth output, or Nth SNR) can be stored in a data storage (or other data storage, local or remote) in association with the Nth client device N. In these implementations, if user R provides, for example, an additional speech (e.g., “Assistant, increase the volume of the TV”), audio data for the additional speech captured by the first device 1 can be multiplied by the first weight value, audio data for the additional speech captured by the second device 2 can be multiplied by the second weight value, . . . , and audio data for the additional speech captured by the Nth device N can be multiplied by the Nth weight value, for combination to generate an additional merged audio signal. The additional merged audio signal can be processed by the client automated assistant 110 for speech recognition, hotword detection, or other tasks/processing, or can be processed by other components not being part of the client automated assistant 110.

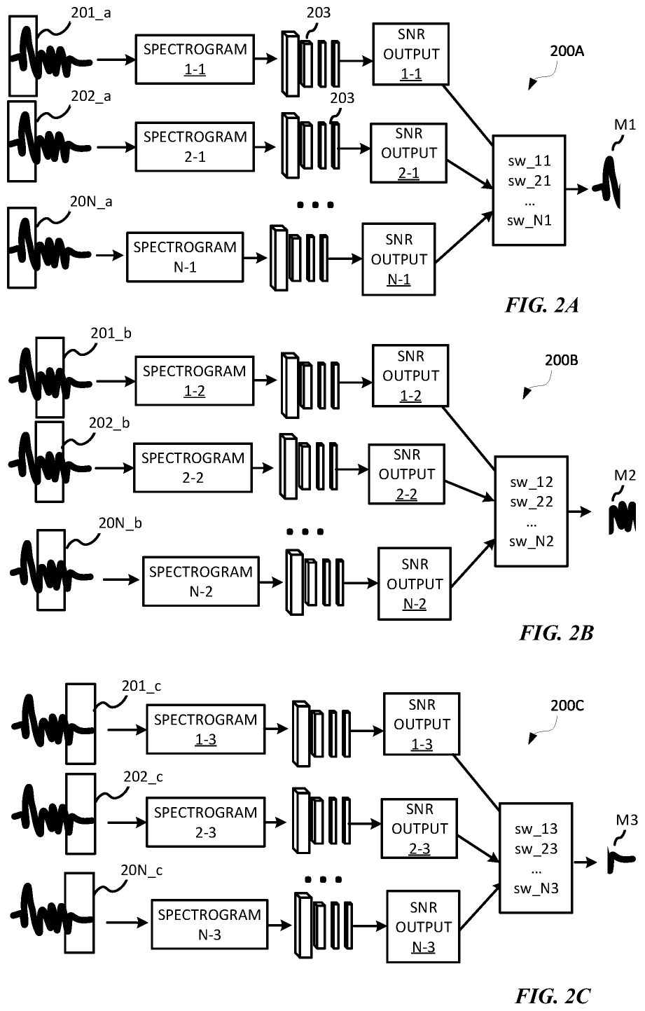

FIG. 2A, FIG. 2B, and FIG. 2C together provide a flow diagram showing the processing of a plurality of audio signals, in accordance with various implementations. As shown in FIG. 2A˜2C, when a user provides a spoken utterance (e.g., “What's in my calendar tomorrow”), a first client device (e.g., first client 1 in FIG. 1A) can collect a first raw audio signal (i.e., audio signal captured by one or more microphones of the first client device) for the spoken utterance, a second client device (e.g., second client device 2 in FIG. 1A) can collect a second raw audio signal for the spoken utterance, . . . , and the Nth client device (e.g., the Nth client device N in FIG. 1A) can collect an Nth raw audio signal for the spoken utterance. The first, second, . . . , and the Nth raw audio signals can be respectively divided into one or more groups of audio frames.

For instance, referring to FIGS. 2A˜2C, the first raw audio signal can be divided into: a first group of audio frames 201_a, a second group of audio frames 201_b succeeding the first group, and a third group of audio frames 201_c succeeding the second group. The second raw audio signal collected by the second client device can be divided into: a first group of audio frames 202_a, a second group of audio frames 202_b succeeding the first group, and a third group of audio frames 202_c succeeding the second group. The Nth raw audio signal collected by the Nth client device can be divided into: a first group of audio frames 20N_a, a second group of audio frames 20N_b succeeding the first group, and a third group of audio frames 20N_c succeeding the second group. The first group of audio frames 201_a, the first group of audio frames 202_a, . . . , and the first group of audio frames 20N_a can include the same number of frames. The second group of audio frames 201_b, the second group of audio frames 202_b, . . . , and the second group of audio frames 20N_b can include the same number of frames. The third group of audio frames 201_c, the third group of audio frames 202_c, . . . , and the third group of audio frames 20N_c can include the same number of frames.

In some implementations, the first, second, . . . , and the Nth raw audio signals can be divided based on detecting one or more triggering events (e.g., based on the time at which the one or more triggering events are detected). One example of a triggering event can be detection of movement of the user with respect to the plurality of client devices (e.g., the first, second, . . . , Nth client devices) or vice versa (e.g., movement of the first client device with respect to the user). Another example of a triggering event can be detection of a loud noise (e.g., alarm). The one or more triggering events can be, or can include, any other applicable triggering event, and the present disclosure is not limited thereto. Given the non-limiting example illustrated in FIGS. 2A˜2C, the first groups of audio frames (201_a, 202_a, . . . , 20N_a) can correspond to a first level of background noise (e.g., living room environment with TV being on), the second groups of audio frames (201_b, 202_b, . . . , 20N_b) can correspond to a second level of background noise (e.g., living room environment with phone ringing and TV remaining on), and the third groups of audio frames (201_c, 202_c, . . . , 20N_c) can correspond to a third level of background noise (e.g., living room environment with TV in a silent mode).

Continuing with FIG. 2A, the first groups of audio frames (201_a, 202_a, . . . , 20N_a) can be respectively processed for feature extraction to generate a spectrogram 1_1 (a digital or image representation of the first group of audio frames 201_a), a spectrogram 2_1, . . . , and a spectrogram N_1. The spectrogram 1_1, the spectrogram 2_1, . . . , and the spectrogram N_1 can be respectively processed using a trained neural network 203 to generate a SNR output 1_1 indicating a SNR for the first group of audio frames 201_a, a SNR output 2_1 indicating a SNR for the first group of audio frames 202_a, . . . , and a SNR output N_1 indicating a SNR for the first group of audio frames 202_N. Based on the SNR output 1_1, the SNR output 2_1, . . . , the SNR output N_1, a first weight value sw_11, a second weight value sw_21, . . . , and an Nth weight value sw_N1 can be determined.

The first group of audio frames 201_a, the first group of audio frames 202_a, . . . , and the first group of audio frames 20N_a can be combined, based on the first weight value sw_11, the second weight value sw_21, . . . , and the Nth weight value sw_N1, to generate a first portion M1 of merged audio signal. For instance, the first group of audio frames 201_a multiplied by the first weight value sw_11, the first group of audio frames 202_a multiplied by the second weight value sw_21, . . . , and the first group of audio frames 20N_a multiplied by the Nth weight value sw_N1, can be combined to generate the first portion M1.

Referring to FIG. 2B, the second groups of audio frames (201_b, 202_b, . . . , 20N_b) can be respectively processed for feature extraction to generate a spectrogram 1_2, a spectrogram 2_2, . . . , and a spectrogram N_2. The spectrogram 1_2, the spectrogram 2_2, . . . , and the spectrogram N_2 can be respectively processed using the trained neural network 203 to generate a SNR output 1_2 indicating a SNR for the second group of audio frames 201_b, a SNR output 2_2 indicating a SNR for the second group of audio frames 202_b, . . . , and a SNR output N_2 indicating a SNR for the second group of audio frames 20N_b. Based on the SNR output 1_2, the SNR output 2_2, . . . , the SNR output N_2, the first weight value sw_11 can be modified/updated to sw_12, the second weight value sw_21 can be updated to sw_22, . . . , and the Nth weight value sw_N1 can be updated to sw_N2. The second group of audio frames 201_b, the second group of audio frames 202_b, . . . , and the second group of audio frames 20N_b can be combined, based on the updated first weight value sw_12, the updated second weight value sw_22, . . . , and the updated Nth weight value sw_N2, to generate a second portion M2 of the merged audio signal.

Referring to FIG. 2C, the third groups of audio frames (201_c, 202_c, . . . , 20N_c) can be respectively processed for feature extraction to generate a spectrogram 1_3, a spectrogram 2_3, . . . , and a spectrogram N_3. The spectrogram 1_3, the spectrogram 2_3, . . . , and the spectrogram N_3 can be respectively processed using the trained neural network 203 to generate a SNR output 1_3 indicating a SNR for the third group of audio frames 201_c, a SNR output 2_3 indicating a SNR for the third group of audio frames 202_c, . . . , and a SNR output N_3 indicating a SNR for the third group of audio frames 20N_c. Based on the SNR output 1_3, the SNR output 2_3, . . . , the SNR output N_3, the first weight value sw_11 can be further modified/updated to sw_13, the second weight value sw_21 can be updated to sw_23, . . . , and the Nth weight value sw_N1 can be updated to sw_N3. The third group of audio frames 201_c, the third group of audio frames 202_c, . . . , and the third group of audio frames 20N_c can be combined, based on the further updated first weight value sw_13, the further updated third weight value sw_23, . . . , and the further updated Nth weight value sw_N3, to generate a third portion M3 of the merged audio signal. Optionally, the first portion M1, the second portion M2, and the third portion M3 can combined by configuring the second portion M2 succeeding the first portion M1 and configuring the third portion M3 succeeding the second portion M2, to form a single audio signal that corresponds to the spoken utterance (e.g., “What's in my calendar tomorrow”) in its entirety.

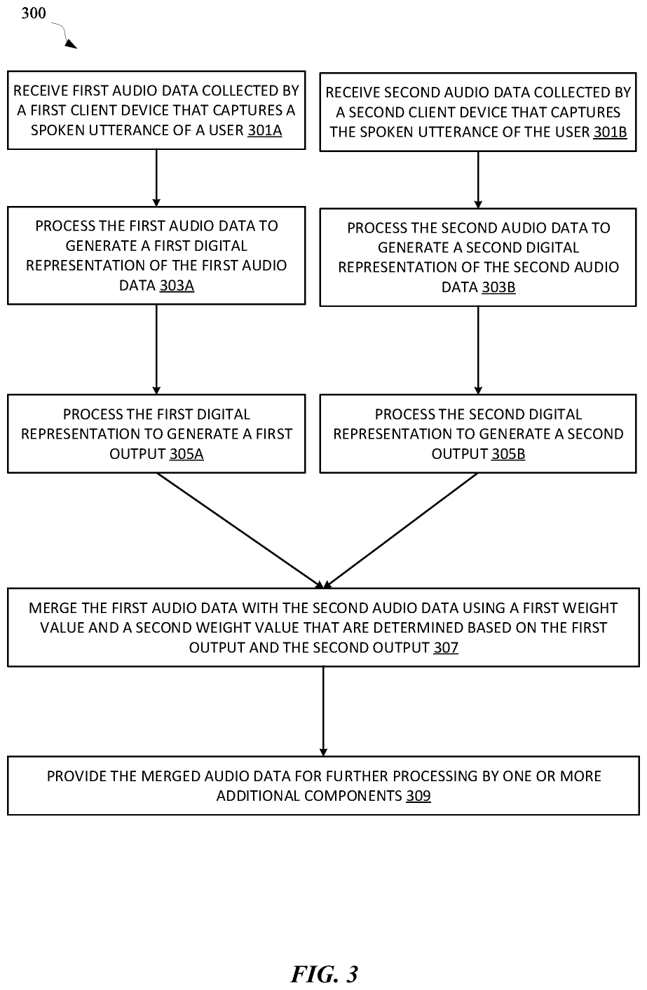

FIG. 3 illustrates an example method for generating a merged audio signal, in accordance with various implementations. For convenience, the operations of the method 300 are described with reference to a system that performs the operations. The system of method 300 includes one or more processors and/or other component(s) of a client device and/or of a server device. Moreover, while operations of the method 300 are shown in a particular order, this is not meant to be limiting. One or more operations may be reordered, omitted, or added.

Referring to FIG. 3, in various implementations, at block 301A, the system can receive first audio data that is collected by one or more microphones of a first computing device (e.g., the first client device 1 in FIG. 1A) and that captures a spoken utterance of a user. At block 301B, the system can receive second audio data that is collected by one or more microphones of a second computing device (e.g., the second client device 2 in FIG. 1A) and that captures the spoken utterance of the user. The first and second computing devices can be both in an environment surrounding the user and can be distinct from each other. The first and second computing devices can have different orientations and/or distances with respect to the user.

In various implementations, at block 303A, the system can process the first audio data to generate a first digital (e.g., two-dimensional image) representation for the first audio data. In various implementations, at block 303B, the system can process the second audio data to generate a second digital (e.g., two-dimensional image) representation for the second audio data. The first digital or image representation of the spoken utterance can be a first spectrogram defining or showing variation of frequency along with time for the first audio data, and the second digital or image representation of the spoken utterance can be a second spectrogram showing or defining variation of frequency along with time for the second audio data.

In some implementations, the system can process the first and second audio data, using a server device (e.g., the first server device 11 in FIG. 1A) that is remote to the first and second computing devices. Alternatively, the system can process the first and second audio data, using the first computing device and/or the second computing device. For example, the system can process the first audio data using the first computing device, and process the second audio data using the second computing device. As another example, the second audio data can be transmitted by the second computing device to the first computing device, and the first computing device can process the first and second audio data respectively. In some implementations, the first and second computing devices can be the only local devices surrounding the user. In some other implementations, the environment surrounding the user can include other local devices (e.g., a third computing device) in addition to the first and second computing devices. In these implementations, the third computing device can receive and process the first and second audio data.

In various implementations, at block 305A, the system can process, using a trained neural network model (e.g., the trained neural network 1151 in FIG. 1A), the first digital or image representation of the first audio data as input (“first input”), to generate a first output that reflects a first signal-to-noise ratio (SNR) predicted for the first audio data. In various implementations, at block 305B, the system can process, using the trained neural network model (e.g., the trained neural network 1151 in FIG. 1A), the second digital or image representation of the second audio data as input (“second input”), to generate a second output that reflects a second SNR predicted for the second audio data.

The system can process the first and second digital representations at a server device (e.g., the first server device 11 in FIG. 1A), or at one or more local devices (e.g., the first and/or second computing devices). For example, the server device can include, or access, the aforementioned trained neural network model, to process the first digital representation to generate the first output, and process the second digital representation to generate the second output.

As another example, the first computing device can include, or access, a model the same as or similar to the aforementioned trained neural network model, to process the first digital representation and thereby generating the first output, and the second computing device can include, or access, a model the same as or similar to the aforementioned trained neural network model, to process the second digital representation thereby generating the second output.

As a further example, the second computing device can transmit the second digital representation and/or the second audio signal to the first computing device. In this example, the first computing device can process the first digital representation, using a machine learning (ML) model (e.g., trained to process spectrograms), to generate the first output. The first computing device can further process the second digital representation, using the ML model, to generate the second output.

In various implementations, at block 307, the system can merge the first audio data and the second audio data. The system can merge the first and second audio data using a first weight value and a second weight value, where the first and second weight values can be determined based on the first output and the second output. In some implementations, the system can merge the first audio data multiplied by the first weight value and the second audio data multiplied by the second weight value, to generate merged audio data for the spoken utterance. In these implementations, the first weight value and the second weight value can be determined based on the first output that reflects the first SNR and the second output that reflects the second SNR. As a non-limiting example, the first weight value can be determined by dividing the first output by a sum of the first output and the second output (assuming client devices that surround the user include only the first and second computing devices), and the second weight value can be determined by dividing the second output by the sum of the first output and the second output. In this non-limiting example, a ratio of the first weight value with respect to the second weight value can be the same as a ratio of the first output indicating the first SNR predicted for the first audio data with respect to the second output indicating the second SNR predicted for the second audio data.

In some implementations, the first and second weight values (and additional weight values, if there is any) can be determined using a server device (e.g., the first server device 11 in FIG. 1A). In some implementations, the first and second weight values (and additional weight values, if there is any) can be determined using a local client device (e.g., the first computing device, or the second computing device).

In various implementations, at block 309, the system can provide the merged audio data for further processing by one or more additional components. As a non-limiting example, the one or more additional components, for instance, can include an ASR engine (e.g., the ASR engine 1101 in FIG. 1A). In this example, the system can provide the merged audio data for processing by the ASR engine, to generate a recognition of the spoken utterance of the user. As another non-limiting example, the one or more additional components, for instance, can include an invocation engine (e.g., the invocation engine 1102 in FIG. 1A) for an automated assistant. In this example, the system can provide the merged audio data for further processing by the invocation engine, to determine whether to invoke the automated assistant or not.

In some implementations, the system can store the first weight value in a local database in association with the first computing device, and store the second weight value in the local database in association with the second computing device.

In some implementations, the system can receive first additional audio data from the first computing device that captures an additional spoken utterance and receive second additional audio data from the second computing device that captures the additional spoken utterance. In these implementations, the system can merge the first additional audio data multiplied with the first weight value and the second additional audio data multiplied with the second weight value to generate additional merged audio data, without using the trained neural network to re-compute or update the first and second weight values. The system can process the additional merged audio data to recognize the additional spoken utterance.

In some implementations, prior to receiving the first additional audio data and the second additional audio data, the system can determine that, relative to generating the merged audio data, no change in location and orientation has been detected for the first computing device and no change in location and orientation has been detected for the second computing device. In these implementations, merging the first additional audio data multiplied with the first weight value and the second additional audio data multiplied with the second weight value to generate the additional merged audio data, can be based on determining that no change in the location and the orientation has been detected for the first computing device and no change in the location and the orientation has been detected for the second computing device.

In some implementations, the location and orientation associated with the first computing device are relative to the user, and the location and orientation associated with the second computing device are also relative to the user.

In some implementations, the first computing device can include a first motion sensor, and the second computing device includes a second motion sensor. In these implementations, determining that no change in location and orientation has been detected for the first computing device and for the second computing device can include: detecting, using the first motion sensor, no change in the location and orientation for the first computing device; and detecting, using the second motion sensor, no change in the location and orientation for the second computing device. The first (or second) motion sensor can be, for instance, an accelerometer, a gyroscope, and/or other types of motion sensors (or any combination thereof) embedded in the first (or second) client device, that determines whether the first (or second) client device moves in respect to location and/or orientation.

In some implementations, the system can detect a change in location and/or orientation to the first (or second) computing device. In these implementations, subsequent to detecting the change in the location and/or the orientation to the first computing device, the system can receive further first audio data from the first computing device that captures a further spoken utterance, and receive further second audio data from the second computing device that captures the further spoken utterance. The system can process the further first audio data to determine a further first image representation of the further first audio data, and process the further first audio data to determine a further second image representation of the further second audio data. Further, the system can process, using the trained neural network, the further first image representation of the further first audio data, to generate a further first output indicating an updated first SNR predicted for the further first audio data; and process, using the trained neural network, the further second image representation of the further second audio data as input, to generate a further second output indicating an updated second SNR predicted for the further second audio data.

The system can merge the further first audio data multiplied by an updated first weight value with the second audio data multiplied by an updated second weight value to generate further merged audio data. The updated first weight value and the updated second weight value can be determined based on the further first output indicating the updated first SNR and the further second output indicating the updated second SNR. For instance, the updated first weight value can be determined by dividing the further first output by a sum of the further first output and the further second output, and the updated second weight value can be determined by dividing the further second output by the sum of the further first output and the further second output. In some implementations, the first weight value can be greater than the second weight value, which indicates that the first audio data contains less noise than does the second audio data.

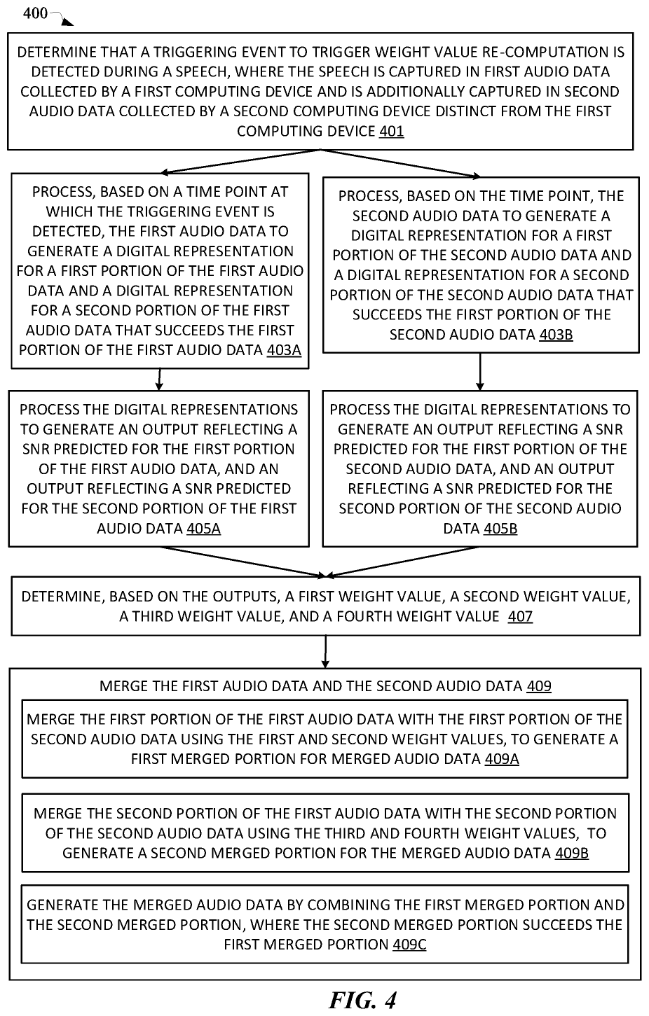

FIG. 4 illustrates an example method for generating or updating (e.g., during a speech) one or more weight values for generation of a merged audio signal, in accordance with various implementations. For convenience, the operations of the method 400 are described with reference to a system that performs the operations. The system of method 400 includes one or more processors and/or other component(s) of a client device and/or of a server device. Moreover, while operations of the method 400 are shown in a particular order, this is not meant to be limiting. One or more operations may be reordered, omitted, or added.

Referring to FIG. 4, in various implementations, at block 401, the system can determine that a triggering event to trigger weight value re-computation is detected during a speech (e.g., the speech 151 “Assistant, turn on the TV” in FIG. 1A, may also be referred to as “spoken utterance”) of a user, where the speech is captured in first audio data collected by one or more microphones of a first computing device, and the speech is additionally captured in second audio data collected by one or more microphones of a second computing device. The first and second computing devices can be both in an environment surrounding the user and can be distinct from each other.

In various implementations, the triggering event can be detection of increased noise within the environment. Alternatively or additionally, the triggering event can be detection of movement of the user, which results in a change of a location and/or orientation of the user with respect to the first computing device and the second computing device. Alternatively or additionally, the triggering event can be detection of movement of the first (or second) computing device, which results in a change of a location and/or orientation of the first (or second) computing device with respect to the user.

At block 403A, the system can process, based on a time point at which the triggering event is detected, the first audio data to generate a digital representation for a first portion of the first audio data and a digital representation for a second portion of the first audio data that succeeds the first portion of the first audio data. At block 403B, the system can process, based on the time point at which the triggering event is detected, the second audio data to generate a digital representation for a first portion of the second audio data and a digital representation for a second portion of the second audio data that succeeds the first portion of the second audio data. The first portion of the second audio data can correspond to the first portion of the first audio data (e.g., both capturing a first half of the speech), and the second portion of the second audio data can correspond to the second portion of the first audio data (e.g., both capturing a second half portion of the speech).

At block 405A, the system can process, using a trained neural network, the digital representation for the first portion of the first audio data, and the digital representation for the second portion of the first audio data, respectively, to generate: an output (“OUTPUT11”) reflecting a signal-to-noise ratio (SNR) predicted for the first portion of the first audio data, and an output (“OUTPUT 12”) reflecting a SNR predicted for the second portion of the first audio data. Additionally, at block 405B, the system can process, using the trained neural network, the digital representation for the first portion of the second audio data, and the digital representation for the second portion of the second audio data, respectively, to generate: an output (“OUTPUT 21”) reflecting a SNR predicted for the first portion of the second audio data, and an output (“OUTPUT 22”) reflecting a SNR predicted for the second portion of the second audio data. The first portion of the second audio data corresponds to the first portion of the first audio data, and the second portion of the second audio data corresponds to the second portion of the first audio data.

In various implementations, the trained neural network is a convolutional neural network (CNN) trained to process a digital (e.g., image) representation of audio data to predict SNR for the audio data. The digital representation of audio data processed by the trained CNN can be, for instance, a spectrogram of the audio data showing variation of a frequency of the audio data with time.

At block 407, the system can determine a first weight value, a second weight value, a third weight value, and a fourth weight value, based on the four outputs described at blocks 405A and 405B (i.e., OUTPUT11, OUTPUT 12, OUTPUT 21, and OUTPUT 22). In some implementations, the system can determine the first and second weight values based on the output (“OUTPUT11”) reflecting the SNR predicted for the first portion of the first audio data and based on the output (“OUTPUT21”) reflecting the SNR predicted for the first portion of the second audio data. In these implementations, the system can determine the third and fourth weight values based on the output (“OUTPUT12”) reflecting the SNR predicted for the second portion of the first audio data and based on the output (“OUTPUT22”) reflecting the SNR predicted for the second portion of the second audio data.

For instance, the first weight value can be determined by dividing OUTPUT 11 by a sum of OUTPUT 11 and OUTPUT 21, the second weight value can be determined by dividing OUTPUT 21 by the sum of OUTPUT 11 and OUTPUT 21. In this instance, the third weight value (may also referred to as “updated first weight value”) can be determined by dividing OUTPUT 12 by a sum of OUTPUT 12 and OUTPUT 22, and the fourth weight value (may also be referred to as “updated second weight value”) can be determined by dividing OUTPUT 22 by the sum of OUTPUT 12 and OUTPUT 22. The first and second weight values can then be used to merge the first portion of the first audio data and the first portion of the second audio data. The third and fourth weight values can be used to merge the second portion of the first audio data and the second portion of the second audio data.

At block 407, the system can merge the first audio data and the second audio data, to generate merged audio data for the speech of the user. To merge the first and second audio data, the system can, at block 407A, merge the first portion of the first audio data and the first portion of the second audio data, using the first and second weight values, to generate a first merged portion for the merged audio data. The system can further, at block 407B, merge the second portion of the first audio data and the second portion of the second audio data, using the third and fourth weight values, to generate a second merged portion for the merged audio data. The system can further, at block 407C, generate the merged audio data for the speech of the user by combining the first and second merged portion, where the second merged portion succeeds the first merged portion.

For instance, the system can merge the first portion of the first audio data weighted with the first weight value with the first portion of the second audio data weight with the second weight value. The system can merge the second portion of the first audio data weighted with the first weight value with the second portion of the second audio data weighted with the second weight value.

In some implementations, prior to block 401, the system can monitor for one or more predetermined triggering events (e.g., the movement of the first computing device, the movement of the second computing device, noise exceeding a predetermined volume, e.g., 75 dB for 0.5 s, and/or movement of the user, etc.). If no triggering event is detected during the speech, the first audio data does not need to be divided and the second audio data does not need to be divided. In this way, weight value for the first audio does not need to be updated/re-computed for different portions for the first audio data, and weight value for the second audio data does not need to be updated/re-computed for different portions of the second audio data. In various implementations, the trained neural network is a convolutional neural network (CNN) trained to process an image representation of audio data to predict SNR for the audio data. The image representation of audio data processed by the trained CNN can be, for instance, a spectrogram of the audio data showing variation of a frequency of the audio data with time.

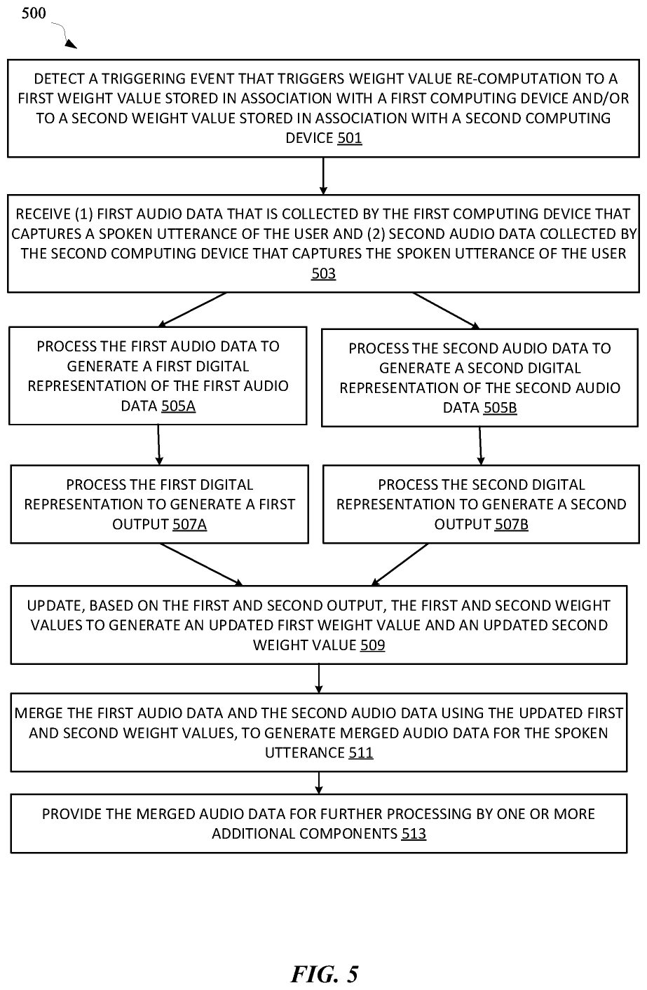

FIG. 5 illustrates an example method for dynamically updating one or more weight values, in accordance with various implementations. For convenience, the operations of the method 500 are described with reference to a system that performs the operations. The system of method 500 includes one or more processors and/or other component(s) of a client device and/or of a server device. Moreover, while operations of the method 500 are shown in a particular order, this is not meant to be limiting. One or more operations may be reordered, omitted, or added.

Referring to FIG. 5, in various implementations, at block 501, the system can detect a triggering event that triggers weight value recomputation to a first weight value stored in association with a first computing device and/or to a second weight value stored in association with a second computing device, where the first and second computing devices are located within an environment of a user. As a non-limiting example, the triggering event can be detection of a noise within the environment. As another non-limiting example, the triggering event can be detection of a change in location or orientation of the first (or second) computing device with respect to the user.

At block 503, subsequent to detecting the triggering event, the system can receive (1) first audio data that is collected by one or more microphones of the first computing device and that captures a spoken utterance of the user and (2) second audio data that is collected by one or more microphones of the second computing device and that captures the spoken utterance of the user.

At block 505A, the system can process the first audio data to generate a first digital representation for the first audio data. At block 505B, the system can process the second audio data to generate a second digital representation for the second audio data.

At block 507A, the system can process, using a trained neural network model, the first digital representation of the first audio data as input, to generate a first output that reflects a first signal-to-noise ratio (SNR) predicted for the first audio data. At block 507B, the system can process, using the trained neural network model, the second digital representation of the second audio data as input, to generate a second output that reflects a second SNR predicted for the second audio data.

At block 509, the system can update, based on the first and second outputs, the first weight value and the second weight value. For instance, the system can (i) update, based on the first and second outputs, the first weight value to generate an updated first weight value, and (ii) update, based on the first and second outputs, the second weight value to generate an updated second weight value.

At block 511, the system can merge the first audio data and the second audio data using the updated first weight value and the updated second weight value, to generate merged audio data for the spoken utterance. For instance, the system can merge the first audio data multiplied by the updated first weight value with the second audio data multiplied by the updated second weight value, to generate the merged audio data.

At block 513, the system can provide the merged audio data for further processing by one or more additional components (e.g., an ASR engine or an invocation engine, etc.).

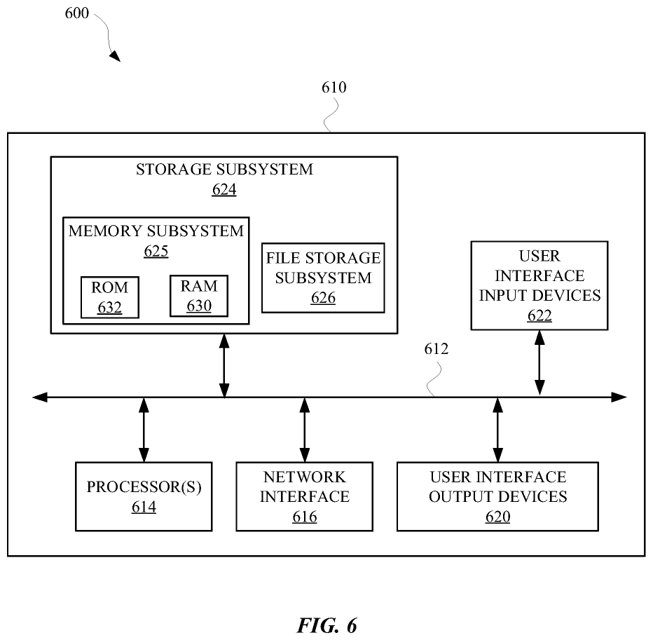

FIG. 6 is a block diagram of an example computing device 610 that may optionally be utilized to perform one or more aspects of techniques described herein. In some implementations, one or more of a client computing device, cloud-based automated assistant component(s), and/or other component(s) may comprise one or more components of the example computing device 610.

Computing device 610 typically includes at least one processor 614 which communicates with a number of peripheral devices via bus subsystem 612. These peripheral devices may include a storage subsystem 624, including, for example, a memory subsystem 625 and a file storage subsystem 626, user interface output devices 620, user interface input devices 622, and a network interface subsystem 616. The input and output devices allow user interaction with computing device 610. Network interface subsystem 616 provides an interface to outside networks and is coupled to corresponding interface devices in other computing devices.

User interface input devices 622 may include a keyboard, pointing devices such as a mouse, trackball, touchpad, or graphics tablet, a scanner, a touch screen incorporated into the display, audio input devices such as voice recognition systems, microphones, and/or other types of input devices. In general, use of the term “input device” is intended to include all possible types of devices and ways to input information into computing device 610 or onto a communication network.

User interface output devices 620 may include a display subsystem, a printer, a fax machine, or non-visual displays such as audio output devices. The display subsystem may include a cathode ray tube (CRT), a flat-panel device such as a liquid crystal display (LCD), a projection device, or some other mechanism for creating a visible image. The display subsystem may also provide non-visual display such as via audio output devices. In general, use of the term “output device” is intended to include all possible types of devices and ways to output information from computing device 610 to the user or to another machine or computing device.

Storage subsystem 624 stores programming and data constructs that provide the functionality of some or all of the modules described herein. For example, the storage subsystem 624 may include the logic to perform selected aspects of the methods disclosed herein, as well as to implement various components depicted in FIG. 1A.

These software modules are generally executed by processor 614 alone or in combination with other processors. Memory 625 used in the storage subsystem 624 can include a number of memories including a main random access memory (RAM) 630 for storage of instructions and data during program execution and a read only memory (ROM) 632 in which fixed instructions are stored. A file storage subsystem 626 can provide persistent storage for program and data files, and may include a hard disk drive, a floppy disk drive along with associated removable media, a CD-ROM drive, an optical drive, or removable media cartridges. The modules implementing the functionality of certain implementations may be stored by file storage subsystem 626 in the storage subsystem 624, or in other machines accessible by the processor(s) 614.

Bus subsystem 612 provides a mechanism for letting the various components and subsystems of computing device 610 communicate with each other as intended. Although bus subsystem 612 is shown schematically as a single bus, alternative implementations of the bus subsystem may use multiple buses.

Computing device 610 can be of varying types including a workstation, server, computing cluster, blade server, server farm, or any other data processing system or computing device. Due to the ever-changing nature of computers and networks, the description of computing device 610 depicted in FIG. 6 is intended only as a specific example for purposes of illustrating some implementations. Many other configurations of computing device 610 are possible having more or fewer components than the computing device depicted in FIG. 6.

Different features of the examples can be combined or interchanged, unless they are not combinable nor interchangeable.

While several implementations have been described and illustrated herein, a variety of other means and/or structures for performing the function and/or obtaining the results and/or one or more of the advantages described herein may be utilized, and each of such variations and/or modifications is deemed to be within the scope of the implementations described herein. More generally, all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific implementations described herein. It is, therefore, to be understood that the foregoing implementations are presented by way of example only and that, within the scope of the appended claims and equivalents thereto, implementations may be practiced otherwise than as specifically described and claimed. Implementations of the present disclosure are directed to each individual feature, system, and/or method described herein. In addition, any combination of two or more such features, systems, and/or methods, if such features, systems, and/or methods are not mutually inconsistent, is included within the scope of the present disclosure.

In some implementations, a computer-implemented method is provided, and includes: receiving first audio data that is collected by one or more first microphones of a first computing device and that captures a spoken utterance of a user, and receiving second audio data that is collected by one or more second microphones of a second computing device and that captures the spoken utterance of the user, wherein the first and second computing devices are both in an environment of the user and are distinct from each other.

In various implementations, the method can further include, processing, using a trained neural network model: a first audio data first portion of the first audio data to generate a first output reflecting a first signal-to-noise ratio (SNR) for the first portion of the first audio data, a first audio data second portion of the first audio data to generate a second output reflecting a second SNR for the first audio data second portion, a second audio data first portion of the second audio data to generate a third output reflecting a third SNR for the second audio data first portion, a second audio data second portion of the second audio data to generate a fourth output reflecting a fourth SNR for the second audio data second portion. The first audio data first portion temporally corresponds to the second audio data first portion and the first audio data second portion temporally corresponds to the second audio data second portion. The trained neural network can be, for instance, a convolutional neural network (CNN) trained to process a digital representation of audio data, to predict SNR for the audio data.

In various implementations, the method can further include: merging the first audio data and the second audio data to generate merged audio data, where the merging include: generating a first portion of the merged audio data based on the first audio data first portion, the second audio data first portion, and based on the first output and the third output; and generating a second portion of the merged audio data based on the first audio data second portion, the second audio data second portion, and based on the second output and the fourth output.

In some implementations, the method can further include: detecting, during the spoken utterance, occurrence of a triggering event. In these implementations, processing, using the trained neural network model, the first audio data second portion and the second audio data second portion, to generate the second output and the fourth output, is in response to detecting the occurrence of the triggering event. As a non-limiting example, the triggering event is detection of increased noise within the environment. As another non-limiting example, the triggering event is detection of movement of the first or second computing device. In some implementations, the method can further include: providing the combined audio data for further processing by an automatic speech recognition (ASR) engine to generate a speech recognition of the spoken utterance.

In some implementations, another computer-implemented method is provided, and includes: processing, using a trained neural network model, a first digital representation of first audio data as first input, to generate a first output that reflects a first signal-to-noise ratio (SNR) predicted for the first audio data, where the first audio data captures a spoken utterance of a user and is collected by one or more first microphones of a first computing device within an environment of the user. In these implementations, the method can further include: processing, using the trained neural network model, the second digital representation of the second audio data as second input, to generate a second output that reflects a second SNR predicted for the second audio data, where the second audio data captures the spoken utterance of the user and is collected by one or more second microphones of a second computing device within the environment.

In some implementations, the first digital representation of the first audio data is a first spectrogram showing variation of frequency along time for the first audio data, and the second digital representation of the first audio data is a second spectrogram showing variation of frequency along time for the second audio data.

In some implementations, the first and second computing devices are distinct from each other. For instance, the first and second computing devices can have different orientations and/or distances with respect to the user. In some implementations, the location and orientation associated with the first computing device are relative to the user, and the location and orientation associated with the second computing device are also relative to the user.

In some implementations, the method can further include: merging the first audio data and the second audio data to generate merged audio data for the spoken utterance. The merging here can include using a first weight value for the first audio data in the merging and using a second weight value for the second audio data in the merging, where the first weight value and the second weight value are determined based on the first output that reflects the first SNR and the second output that reflects the second SNR.

In some implementations, a ratio of the first weight value with respect to the second weight value can be the same as a ratio of the predicted SNR for the first audio data with respect to the predicted SNR for the second audio data. In some implementations, the first weight value is greater than the second weight value, indicating that the first audio data contains less noise than does the second audio data.

In some implementations, the method can further include: providing the merged audio data for further processing by one or more additional components. The one or more additional components, for example, can be, or include, an automatic speech recognition (ASR) engine. In this case, the method can further include: processing the merged audio data, using the ASR engine, to generate a recognition of the spoken utterance of the user.

In some implementations, the method can further include: storing the first weight value in association with the first computing device; and storing the second weight value in association with the second computing device.

In some implementations, the method can further include: receiving first additional audio data, from the first computing device, that captures an additional spoken utterance; receiving second additional audio data, from the second computing device, that captures the additional spoken utterance; merging the first additional audio data and the second additional audio data to generate additional merged audio data, where the merging to generate the additional merged audio data comprises using the stored first weight value and the stored second weight value without using the trained neural network to re-compute the first and second weight values.

In some implementations, merging the first audio data and the second audio data comprises: merging the first audio data weighted with the first weight value with the second audio data weighted with the second audio data, to generate the merged audio data for the spoken utterance.

In some implementations, the method can further include: processing the additional merged audio data to recognize the additional spoken utterance.

In some implementations, prior to receiving the first additional audio data and the second additional audio data, the method can further include: determining that, relative to generating the merged audio data, no change in location and orientation has been detected for the first computing device and no change in location and orientation has been detected for the second computing device. In these implementations, using the stored first weight value and the stored second weight value, in the merging to generate the additional merged audio data, is based on determining that no change in the location and the orientation has been detected for the first computing device and no change in the location and the orientation has been detected for the second computing device.

In some implementations, the first computing device includes a first motion sensor, and the second computing device includes a second motion sensor. In these implementations, determining that no change in location and orientation has been detected for the first computing device and for the second computing device includes: detecting, based on first sensor data from the first motion sensor, no change in the location and orientation for the first computing device; and detecting, based on second sensor data from the second motion sensor, no change in the location and orientation for the second computing device.

In some implementations, the method can further include: detecting a change in location and/or orientation of the first computing device. Subsequent to detecting the change in the location and/or the orientation of the first computing device, the method can include: receiving further first audio data, from the first computing device, that captures a further spoken utterance, and receiving further second audio data, from the second computing device, that captures the further spoken utterance. In these implementations, the method can further include: processing the further first audio data to determine a further first digital representation of the further first audio data; processing the further first audio data to determine a further second digital representation of the further second audio data; processing, using the trained neural network, the further first digital representation of the further first audio data as input, to generate a further first output indicating an updated first SNR predicted for the further first audio data; and processing, using the trained neural network, the further second digital representation of the further second audio data as input, to generate a further second output indicating an updated second SNR predicted for the further second audio data. The method here can further include: merging the further first audio data and the second audio data using an updated first weight value and an updated second weight value, to generate further merged audio data, where the updated first and second weight values are determined based on the further first output indicating the updated first SNR and based on the further second output indicating the updated second SNR.

In some implementations, an additional computer-implemented method is provided, and includes: detecting a triggering event that triggers weight value recomputation of a first weight value stored in association with a first computing device and/or of a second weight value stored in association with a second computing device, where the first and second computing devices are located within an environment of a user. Subsequent to detecting the triggering event, the method can include: receiving (1) first audio data that is collected by one or more microphones of the first computing device and that captures a spoken utterance of the user and (2) second audio data that is collected by one or more microphones of the second computing device and that captures the spoken utterance of the user.

In some implementations, the method can further include: processing the first audio data to generate a first digital representation for the first audio data; processing the second audio data to generate a second digital representation for the second audio data; processing, using a trained neural network model, the first digital representation of the first audio data as input, to generate a first output that reflects a first signal-to-noise ratio (SNR) predicted for the first audio data; and processing, using the trained neural network model, the second digital representation of the second audio data as input, to generate a second output that reflects a second SNR predicted for the second audio data.

In some implementations, the method can further include: updating, based on the first and second outputs, the first weight value to generate an updated first weight value; and updating, based on the first and second outputs, the second weight value to generate an updated second weight value.

In some implementations, the method can further include: merging the first audio data and the second audio data to generated merged audio data, wherein the merging comprises using the updated first weight value in merging the first audio data and the updated second weight value in merging the second audio data; and/or providing the merged audio data for further processing by one or more additional components.

In some implementations, the triggering event can be detection of a noise within the environment, or the triggering event is detection of a change in location or orientation of the first or second computing device with respect to the user, or any other applicable event.

What is claimed is:

1. A computer-implemented method, comprising:
processing, using a trained neural network model, a first digital representation of first audio data as first input, to generate a first output that reflects a first signal-to-noise ratio (SNR) predicted for the first audio data, wherein the first audio data captures a spoken utterance of a user and is collected by one or more first microphones of a first computing device within an environment of the user;
processing, using the trained neural network model, the second digital representation of the second audio data as second input, to generate a second output that reflects a second SNR predicted for the second audio data, wherein the second audio data captures the spoken utterance of the user and is collected by one or more second microphones of a second computing device within the environment, and wherein the first and second computing devices are distinct from each other;
merging the first audio data and the second audio data to generate merged audio data for the spoken utterance, wherein the merging comprises using a first weight value for the first audio data in the merging and using a second weight value for the second audio data in the merging, and wherein the first weight value and the second weight value are determined based on the first output that reflects the first SNR and the second output that reflects the second SNR; and
providing the merged audio data for further processing by one or more additional components.

2. The method of claim 1, wherein the one or more additional components include an automatic speech recognition (ASR) engine, and the method further comprising:
processing the merged audio data, using the ASR engine, to generate a recognition of the spoken utterance of the user.

3. The method of claim 1, wherein the first and second computing devices have different orientations and/or distances with respect to the user.

4. The method of claim 1, wherein a ratio of the first weight value with respect to the second weight value is the same as a ratio of the predicted SNR for the first audio data with respect to the predicted SNR for the second audio data.

5. The method of claim 1, further comprising:
storing the first weight value in association with the first computing device; and
storing the second weight value in association with the second computing device.

6. The method of claim 5, further comprising:
receiving first additional audio data, from the first computing device, that captures an additional spoken utterance;
receiving second additional audio data, from the second computing device, that captures the additional spoken utterance;
merging the first additional audio data and the second additional audio data to generate additional merged audio data, wherein the merging to generate the additional merged audio data comprises using the stored first weight value and the stored second weight value without using the trained neural network to re-compute the first and second weight values; and
processing the additional merged audio data to recognize the additional spoken utterance.

7. The method of claim 6, further comprising, prior to receiving the first additional audio data and the second additional audio data:
determining that, relative to generating the merged audio data, no change in location and orientation has been detected for the first computing device and no change in location and orientation has been detected for the second computing device;
wherein using the stored first weight value and the stored second weight value, in the merging to generate the additional merged audio data, is based on determining that no change in the location and the orientation has been detected for the first computing device and no change in the location and the orientation has been detected for the second computing device.

8. The method of claim 7, wherein the location and orientation associated with the first computing device are relative to the user, and the location and orientation associated with the second computing device are also relative to the user.

9. The method of claim 7, wherein:
the first computing device includes a first motion sensor,
the second computing device includes a second motion sensor, and
determining that no change in location and orientation has been detected for the first computing device and for the second computing device comprises:
detecting, based on first sensor data from the first motion sensor, no change in the location and orientation for the first computing device, and
detecting, based on second sensor data from the second motion sensor, no change in the location and orientation for the second computing device.

10. The method of claim 1, further comprising:
detecting a change in location and/or orientation of the first computing device;
subsequent to detecting the change in the location and/or the orientation of the first computing device:
receiving further first audio data, from the first computing device, that captures a further spoken utterance,
receiving further second audio data, from the second computing device, that captures the further spoken utterance,
processing the further first audio data to determine a further first digital representation of the further first audio data,
processing the further first audio data to determine a further second digital representation of the further second audio data,
processing, using the trained neural network, the further first digital representation of the further first audio data as input, to generate a further first output indicating an updated first SNR predicted for the further first audio data,
processing, using the trained neural network, the further second digital representation of the further second audio data as input, to generate a further second output indicating an updated second SNR predicted for the further second audio data; and
merging the further first audio data and the second audio data using an updated first weight value and an updated second weight value, to generate further merged audio data, wherein the updated first and second weight values are determined based on the further first output indicating the updated first SNR and based on the further second output indicating the updated second SNR.

11. The method of claim 1, wherein the first digital representation of the first audio data is a first spectrogram showing variation of frequency along time for the first audio data, and the second digital representation of the first audio data is a second spectrogram showing variation of frequency along time for the second audio data.

12. The method of claim 1, wherein:
the first weight value is greater than the second weight value, indicating that the first audio data contains less noise than does the second audio data.

13. The method of claim 1, wherein merging the first audio data and the second audio data comprises:
merging the first audio data weighted with the first weight value with the second audio data weighted with the second audio data, to generate the merged audio data for the spoken utterance

14. A computer-implemented method, comprising:
receiving first audio data that is collected by one or more first microphones of a first computing device and that captures a spoken utterance of a user;
receiving second audio data that is collected by one or more second microphones of a second computing device and that captures the spoken utterance of the user, wherein the first and second computing devices are both in an environment of the user and are distinct from each other;
processing, using a trained neural network model:
a first audio data first portion of the first audio data to generate a first output reflecting a first signal-to-noise ratio (SNR) for the first portion of the first audio data,
a first audio data second portion of the first audio data to generate a second output reflecting a second SNR for the first audio data second portion,
a second audio data first portion of the second audio data to generate a third output reflecting a third SNR for the second audio data first portion,
a second audio data second portion of the second audio data to generate a fourth output reflecting a fourth SNR for the second audio data second portion,
wherein the first audio data first portion temporally corresponds to the second audio data first portion and wherein the first audio data second portion temporally corresponds to the second audio data second portion;
merging the first audio data and the second audio data to generate merged audio data, the merging comprising:
generating a first portion of the merged audio data based on the first audio data first portion, the second audio data first portion, and based on the first output and the third output; and
generating a second portion of the merged audio data based on the first audio data second portion, the second audio data second portion, and based on the second output and the fourth output.

15. The method of claim 14, further comprising:
detecting, during the spoken utterance, occurrence of a triggering event;
wherein processing, using the trained neural network model, the first audio data second portion and the second audio data second portion, to generate the second output and the fourth output, is in response to detecting the occurrence of the triggering event.

16. The method of claim 14, further comprising:
providing the combined audio data for further processing by an automatic speech recognition (ASR) engine to generate a speech recognition of the spoken utterance.

17. The method of claim 14, wherein the triggering event is detection of increased noise within the environment.

18. The method of claim 14, wherein the triggering event is detection of movement of the first or second computing device.

19. The method of claim 14, wherein the trained neural network is a convolutional neural network (CNN) trained to process a digital representation of audio data to predict SNR for the audio data.

20. A computer-implemented method, comprising:
detecting a triggering event that triggers weight value recomputation of a first weight value stored in association with a first computing device and/or of a second weight value stored in association with a second computing device, wherein the first and second computing devices are located within an environment of a user;
subsequent to detecting the triggering event: receiving (1) first audio data that is collected by one or more microphones of the first computing device and that captures a spoken utterance of the user and (2) second audio data that is collected by one or more microphones of the second computing device and that captures the spoken utterance of the user;
processing the first audio data to generate a first digital representation for the first audio data;
processing the second audio data to generate a second digital representation for the second audio data;
processing, using a trained neural network model, the first digital representation of the first audio data as input, to generate a first output that reflects a first signal-to-noise ratio (SNR) predicted for the first audio data;
processing, using the trained neural network model, the second digital representation of the second audio data as input, to generate a second output that reflects a second SNR predicted for the second audio data;
updating, based on the first and second outputs, the first weight value to generate an updated first weight value;
updating, based on the first and second outputs, the second weight value to generate an updated second weight value;
merging the first audio data and the second audio data to generated merged audio data, wherein the merging comprises using the updated first weight value in merging the first audio data and the updated second weight value in merging the second audio data; and
providing the merged audio data for further processing by one or more additional components.

21. The method of claim 20, wherein the triggering event is detection of a noise within the environment, or the triggering event is detection of a change in location or orientation of the first or second computing device with respect to the user.
